(19) United States
(12) Patent Application Publication
(10) Pub. No.: US 2010/0150682 A1
(43) Pub. Date: Jun. 17, 2010

(54) FORMING, INSERTION AND END CRIMPING OF HELICAL COILS FOR BOOKBINDING

(76) Inventors: Walter D. Klassen, Winnipeg (CA); Matthew G. Desjarlais, Winnipeg (CA)

Correspondence Address: ADE & COMPANY INC., 2157 Henderson Highway, WINNIPEG, MB, R2G1P9, CA

(21) Appl. No.: 12/332,420

(22) Filed: Dec. 11, 2008

(51) Int. Cl. B42B 5/00

(52) U.S. Cl. 412/33

(57) ABSTRACT

Apparatus for binding a book with a helical plastic coil includes a forming mandrel for forming helical coils from a heated elongate plastics material with the coils being cooled on the mandrel and cut to length before being discharged onto an accumulator tray. The coils are individually transported at high speed from a discharge edge of the tray to the insertion device where the coils are inserted into aligned holes at an edge of respective collated books for binding the books. The coils on the tray are heated by a contact heater on the surface of the tray and/or by air blown over the tray to be kept at a temperature above 25 degrees C. to improve crimping of the ends after cutting of the coil to length in the book.

This invention relates to an apparatus for forming and insertion of plastic helical coils in the aligned holes at the edge of a book used in bookbinding and more particularly to an arrangement for improving the formation of a crimped end of the coil at the ends of the book to hold the coil in place.

### BACKGROUND OF THE INVENTION

It is well known that collated books are often bound using a helical coil which passes through aligned holes at one edge of the book. This provides a book which can be easily opened and held at an opened position and is therefore particularly effective for manuals and reference materials. The helical coil at the edge of the book can be formed from a coiled wire or a coiled filament of plastic material. The coiled wire has the significant advantage that it can be more easily inserted. The helical plastic coil has the advantages that it can be manufactured in different colours and therefore provides a particularly attractive appearance as opposed to the strictly utilitarian appearance of the steel wire. Also the plastic coil has the advantage of durability in that metal can bend and retain deformities which interfere with its ongoing performance.

Currently helical coils are produced by rotating the plastic material on a mandrel. The material is heated in order to adopt the diameter and pitch determined by the mandrel. Mandrels are commonly an elongate rod which has a stationary coil guide that guides the material along the rod such that the material adopts the pitch of the coil guide and the diameter of the rod. Many different sized diameters and pitches can be required by a factory producing coiled books. When the coil has been shaped on the mandrel it is cooled by application of forced air generally by a fan so that the plastics cools to a temperature below a setting temperature so that the shape is set. The coil is then cut to length and discharged from the mandrel onto a discharge tray.

In U.S. Pat. No. 6,382,950 of Desjarlais issued May 7, 2002 is disclosed a machine for forming plastic coils in the manner described above. The disclosure of this patent is incorporated herein by reference for details of the forming machine.

In U.S. Pat. No. 6,000,897 of Desjarlais issued Dec. 14, 1999 is disclosed a machine for inserting a plastic coil into aligned holes at the edge of a book for binding of the book.

In U.S. Pat. No. 7,246,982 of Desjarlais issued Jul. 24, 2007 is disclosed a number of improvements for the insertion machine of the above patent. The machine manufactured by the Assignee Gateway incorporating the features of both patents has achieved considerable commercial success and has operated successfully in the insertion of plastic coils automatically. The disclosure of these two patents is incorporated herein by reference for details of the insertion machine.

The combination of the formation machine and the insertion machine to operate together is of course an obvious requirement and Gateway commenced manufacture of such a combined machine in 2000. The combined machine includes an accumulator tray at the discharge of the forming machine and a transport belt for carrying the coils from the tray to the insertion machine. The accumulator acts to take up differences in the rate of coil production relative to the rate of coil insertion so that sufficient numbers of the coils are always available. The number of coils in the tray is controlled by shutting down the formation machine when the number is above a required number and re-starting the machine when the number falls below a set minimum.

### SUMMARY OF THE INVENTION

It is one object of the invention to provide an apparatus for binding a book with a helical plastic coil where the crimping of the ends of the coil after insertion is improved.

According to one aspect of the invention there is provided an apparatus for binding a book with a helical plastic coil comprising:

a forming assembly for forming helical coils from an elongate plastics material;

an insertion assembly for inserting the helical coils into aligned holes at an edge of respective collated books for binding the books;

an end crimping device for engaging and crimping ends of an inserted helical coil for forming a crimped end of the coil to inhibit release of the inserted coil from the collated book

and a heating device for applying heat to the coils after discharge from the forming assembly and prior to engagement thereof by the end crimping device.

According to a second aspect of the invention there is provided an apparatus for binding a book with a helical plastic coil comprising:

a forming assembly for forming helical coils from an elongate plastics material;

an insertion assembly for inserting the helical coils into aligned holes at an edge of respective collated books for binding the books;

an accumulator or staging area onto which the coils are discharged from the forming assembly and on which the coils remain while awaiting insertion;

a transport device for receiving each coil in turn from the accumulator and for transporting each coil in turn to the insertion assembly;

and a hearing device for applying heat to the coils after discharge from the forming assembly and while in the accumulator.

The present inventors have found that, during operation, insertion speed can vary widely due to changes in operator efficiency and to difficulties with the supply and feed of the books to be bound and even can become halted for a period of time. In this case the formed coils can sit too long on the accumulator and thus can become too cool. It has been found that, in a warmer state, the filament material accepts a crimped bend better so as to retain a better angle. Also cutters operate more effectively when working with a warmer material so as that the blades can last longer with less damage and wear.

Thus the heating of the coils to ensure that they are at a sufficient temperature to allow introduction of a desired crimp angle can take place at any point in the apparatus after the formation is complete and before the crimping action is effected. However this is most conveniently and effectively done in an accumulator section or staging section where the coils are often maintained for the longest period.

It has been determined by the inventors by experimentation on existing machines that if the coils are still in warm state from the forming process that they are easier to cut and maintain a better crimp. The crimped end of a warm coil has less of a tendency to relax and more accepting of deformation as opposed to when it is cooled below 25 degrees C. Depending on the rate of consumption by the insertion process, often the coils spend prolonged periods of time on the accumulator and cool to or below 25 C. After experimentation with cool and warm coils it has been determined that if the coils could be kept in a warm state that a better crimped end could be accomplished.

The ideal crimped end for a plastic spiral is preferably of the order of 90 degrees. This angle provides the best insurance that the spiral will not unwind out of the book with normal use. During typical crimping of the plastic coil, a cutting/crimping head cuts the excess length of the spiral and holds approximately 0.25 inch of the spiral and bends it sharply. There is a tendency for this end to spring back because of the memory of the plastic.

The particular angles retained in the crimped end will vary widely depending on the gauge of the filament used in the coil. However, in particular it has been found that an increase in the angle of the order of 5 to 8 degrees is obtained when the material is warm than when it is cool.

Preferably the heating device is arranged so as to maintain the coils at a temperature above 25 degrees C.

Preferably the heating device comprises a fan for generating air flow, a heating element for heating the air flow and an air guide for directing the air onto the coils while in the accumulator.

Alternatively or additionally, the heating device can comprises a contact heating element for engaging and applying heat to a surface on which the coils are arranged to rest while in the accumulator.

The accumulator can conveniently be formed by a tray on which the coils sit.

Preferably the formation assembly and the accumulator tray are arranged such that the coils sit side by side and are released from one edge of the tray onto the transport device.

Preferably the tray is heated by at least one heating element in engagement with the tray.

Preferably the coils on the tray are heated by the heating device which is arranged to generate heated air blown over the tray.

According to a third aspect of the invention there is provided an apparatus for binding a book with a helical plastic coil comprising:

a forming assembly for forming helical coils from an elongate plastics material;

an insertion assembly for inserting the helical coils into aligned holes at an edge of respective collated books for binding the books;

an end crimping device for engaging and crimping ends of an inserted helical coil for forming a crimped end of the coil to inhibit release of the inserted coil from the collated book and an insulation arrangement arranged to prevent cooling of the coils to a temperature below 25 degrees C. after discharge from the forming assembly and prior to engagement thereof by the end crimping device.

The coils as they emerge from the forming machine are typically at a temperature above 30 degrees C. and in the range 35 to 40 degrees C. The present inventors have found that if the coils are crimped at or around this temperature the crimped ends maintain the crimp to a greater angle. It will be appreciated therefore that the maintenance of the temperature of the coils at a temperature above room temperature that is above 25 degrees C. can be achieved either by application of heat or by covering by an insulation material which reduces cooling in ambient air, or by a combination of both of these techniques.

### BRIEF DESCRIPTION OF THE DRAWINGS

One embodiment of the invention will now be described in conjunction with the accompanying drawings in which:

FIG. 1 is a schematic illustration of the apparatus according to the present invention for binding a book with a helical plastic coil including a forming assembly for forming helical coils from an elongate plastics material, an accumulator and a transport device, and an insertion assembly for inserting the helical coils into aligned holes at an edge of respective collated books for binding the books.

FIG. 2 is a vertical cross sectional view of the accumulator of the apparatus of FIG. 1.

FIG. 3 is a top plan view partly broken away of the accumulator of the apparatus of FIG. 1.

FIGS. 4A and 4B are side elevational views of an end of a coil after insertion and the end crimping action showing the angle of the crimped end to the main body of the filament forming the coil using a room temperature coil and a warm coil respectively.

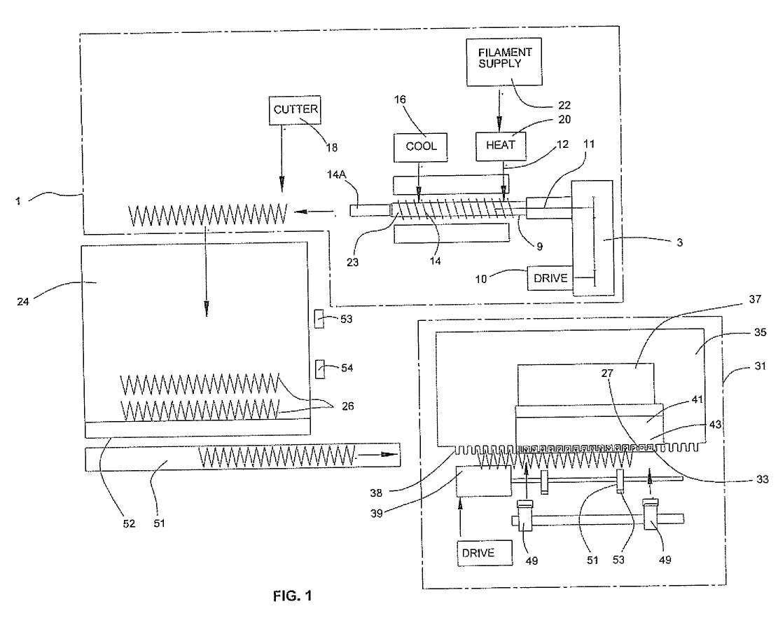

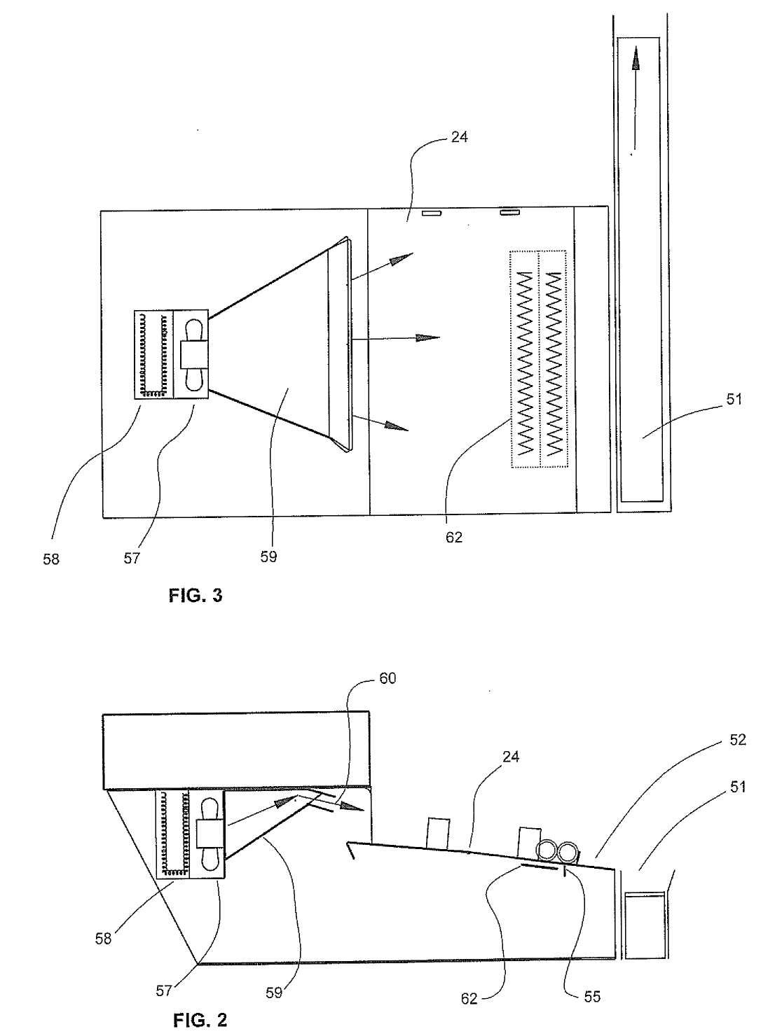

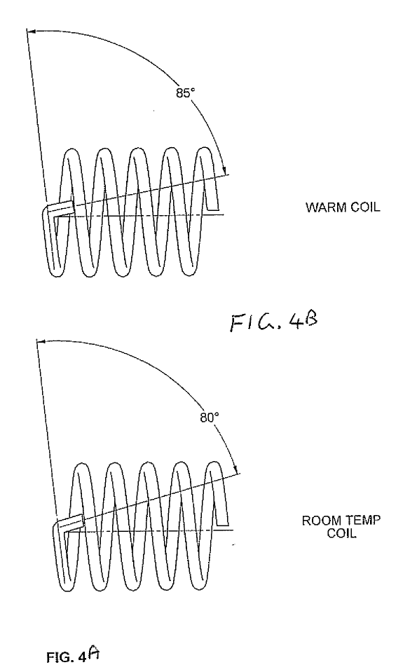

In the drawings like characters of reference indicate corresponding parts in the different figures.

### DETAILED DESCRIPTION

Referring to the accompanying drawings, there is illustrated a coil winding machine, generally indicated by 1, is arranged to wind coils primarily plastic helical bookbinding for insertion in aligned holes at an edge of a book for binding the book. This machine is shown in detail in the above U.S. Pat. No. 6,382,950 of Desjarlais, the disclosure of which is incorporated herein by reference for details of the forming machine.

The machine has a main body 3 which is supported by a frame, not shown. Rotatably mounted to the frame located below the main body is a horizontal shaft 9 which is rotated about a horizontal axis 11 by a motor 10. The shaft forms a mandrel 23 in which a plastic material 12 is wrapped in helical formation guided in its rotation by a stationary helical guide coil 14 which is wrapped around the mandrel and defines a helical guide path around the shaft between turns of the guide coil into which path material is guided for setting into a helical shape having a diameter determined by the diameter of the shaft and a pitch determined by the pitch of the guide coil.

A cooling effect on the filament 12 on the mandrel is provided by a fan 16 which blows air onto a support plate at the mandrel thereby cooling the material on the mandrel. A discharge end 14A of the shaft past the helical guide coil 14 has a diameter which is less than that of the shaft at the helical guide coil so that the coiled material can be released from the shaft to be cut by a cutting device 18.

In operation, a supply of elongate plastic material 12 from a supply 22 is applied to the mandrel through a heating system 20. The mandrel is rotated about the axis such that the material is fed along the mandrel within the turns of the guide coil. The material is rolled along the mandrel. The material is applied in a heated state such that the material is resilient and adopts the diameter of the mandrel and the pitch of the guide coil. The fan applies forced air to the material such that the coiled material is permanently formed with the diameter and pitch desired. The rate of rotation of the mandrel is in direct ratio to the diameter of the mandrel and to the pitch of the coil guide. The rate of rotation is adjusted by changing the speed ratio of the motors which drive the mandrel and a pair of outer rollers.

The cutter assembly 18 is arranged to cut the coiled material to a desired length at the discharge end of the mandrel. The cut material in the form of individual coils 26 is released onto an accumulator tray 24, wherein the coils are arranged side by side in a row along the accumulator.

The machine 31 for coil insertion is shown in detail in the above U.S. Pat. Nos. 6,000,897 and 7,246,982 of Desjarlais, the disclosure of which is incorporated herein by reference for details of the forming machine.

The machine 31 for inserting the plastic pre-formed helical coils 26 into aligned holes 33 at an edge of a collated book 37 for binding has a rubber roller 39 that rotates and moves the coil 26 in a forward direction to be inserted into the aligned holes 33 of the book 37. The rubber roller 39 has a drive roller shaft which extends horizontally from the rubber roller 39. The book 37 is placed on a platen 35 which is located above the roller 39 and extends at an incline upwardly and rearwardly from the roller 39. At the bottom edge of the platen 35 is a comb 38 associated with the roller. The comb 38 has a plurality of teeth which are situated so that the comb 38 guides the coil 26 along the roller 39 into the aligned holes 33 of the book 37.

A book clamp 41 is mounted on the platen 35 and has a front end which is positioned horizontally parallel with the platen 35 and has an inclined front edge 43 which extends downwardly such that the front edge 43 corresponds with the bottom edge of the platen 35. The front edge 43 of the clamp 41 has a clamp comb which is located at the furthermost bottom end of the front edge 43 of the clamp 41 and consists of a plurality of teeth and a plurality of wide spaced teeth 27.

A rocker shaft carries at each end a cutting and bending head 49 which is mounted on the ends of rocker arms and which acts to cut and crimp the ends of the coil after the coil is inserted to a required position. These each comprise a tool which cuts the end and bends the end portion so formed at an angle to the length of the coil filament.

As is well known such crimped end portions are arranged so as to inhibit the end from entering the end hole of the book and thus turning around the axis of the coil allowing the coil to screw itself out of the book edge. Details of such crimping and cutting tools are well known to a person skilled in this art.

Mounted on the first drive roller shaft are first and second drive members 51. The drive members 51 are positioned so that they rotate around the first drive roller shaft intermittently. At the ends of the drive members 51 is a flap member 53.

In operation, when the coil is completed being inserted through the books aligned holes the coil support releases pressure and drops away from the coil so that the cutting and bending heads 49 can be raised by the rocker shaft and proceed to cut the ends of the coil and bend them simultaneously so that the coil remains in place.

When the book is bound the rocker shaft tilts the cutting and bending heads back to the start position, the book clamp releases and the book can now be removed.

In between the forming assembly 1 and the insertion assembly 31 is provided an accumulator tray 24 onto which the coils fall together with a high speed rubber belt conveyor 51 which takes each coil in turn from the end 52 of the tray and carries that coil when required to the insertion station.

The accumulator tray includes devices 53 and 54 for electrically measuring maximum and minimum numbers of coils on the tray so that there is always sufficient coils available as a reservoir to accommodate changes in insertion rates caused by operator difficulty or stoppages. In the event that the maximum number is reached the forming machine is halted. When the number falls to the minimum the forming is re-started.

The tray is a simple inclined pan over which the coils roll by gravity to take up positions side by side against a release device 55 at the lower edge 52. Each time a coil is requested by the insertion device the release device releases a single coil from the bottom edge allowing it to enter the belt conveyor to be carried rapidly to the insertion device.

As the coils can sit on the accumulator tray 24 for variable time periods depending on the rate of insertion and even over longer periods during a shut down, a heating device is provided for applying heat to the coils after discharge from the forming assembly and while on the accumulator.

The heating device is arranged so as to maintain the coils at a temperature above 25 degrees C. and preferably in the range 30 to 40 degrees C. which has been found to provide an improved crimping action at the insertion device. The heating device holds the coils at the raised temperature well above typical room temperature because this warmer temperature holds the plastics material of the coils at a temperature where it can hold the bend formed in the crimping action. While retained at the raised temperature of the order of 30 to 35 degrees C., the crimp generally will retain an angle which is greater by approximately 5 to 8 degrees than the angle obtained when the material is cool or room temperature.

The heating device comprises a fan 57 for generating air flow, a heating element 58 for heating the air flow and an air guide 59 for directing the air onto the coils while on the accumulator tray. These elements are arranged in the housing of the forming machine behind the pan 24 with the guide diverging outwardly in width and converging inwardly in height to form a slot shaped opening 60 though which the air is discharged across the top of the accumulator tray and onto the coils sitting on the accumulator tray. The temperature of the air is roughly of the order of 35 to 45 degrees C. The heating system can be simple with no thermostats since the intention is merely to keep the coils heated generally above 25 degrees C.

In addition the heating device can include contact heating elements 62 engaged onto the underside of the accumulator tray across the discharge edge for applying heat to the accumulator tray on which the coils are arranged to rest while in the accumulator. Thus the coils are heated while they wait by the air from above and are heated as they sit on the discharge end just before they are released to the transfer mechanism. This arrangement has been found to provide sufficient heat to the coils without any danger of heating them sufficiently that they rise to a temperature above the point where they lose their set shape. However the coils at the raised temperature retain a better crimp angle and require less force to cut.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for binding a book with a helical plastic coil comprising:
a forming assembly for forming helical coils from an elongate plastics material;
an insertion assembly for inserting the helical coils into aligned holes at an edge of respective collated books for binding the books;
an accumulator onto which the coils are discharged from the forming assembly and on which the coils remain while awaiting insertion;
a transport device for receiving each coil in turn from the accumulator and for transporting each coil in turn to the insertion assembly;
and a heating device for applying heat to the coils after discharge from the forming assembly and while on the accumulator.

2. The apparatus according to claim 1 wherein the heating device is arranged so as to maintain the coils at a temperature above 25 degrees C. and preferably above 30 degrees C.

3. The apparatus according to claim 1 wherein the heating device comprises a fan for generating air flow, a heating element for heating the air flow and an air guide for directing the air onto the coils while on the accumulator.

4. The apparatus according to claim 1 wherein the heating device comprises a contact heating element for engaging and applying heat to a surface on which the coils are arranged to rest while on the accumulator.

5. The apparatus according to claim 1 wherein the heating device comprises a fan for generating air flow, a heating element for heating the air flow and an air guide for directing the air onto the coils while on the accumulator and a contact heating element for engaging and applying heat to a surface of the accumulator on which the coils are arranged to rest.

6. The apparatus according to claim 1 wherein the accumulator comprises a tray on which the coils sit.

7. The apparatus according to claim 6 wherein the formation assembly and the accumulator tray are arranged such that the coils sit side by side and are released from one edge of the tray onto the transport device.

8. The apparatus according to claim 6 wherein the accumulator tray is heated by at least one heating element in engagement with the accumulator tray.

9. The apparatus according to claim 6 wherein the coils on the accumulator tray are heated by the heating device which is arranged to generate heated air blown over the accumulator tray.

10. Apparatus for binding a book with a helical plastic coil comprising:
a forming assembly for forming helical coils from an elongate plastics material;
an insertion assembly for inserting the helical coils into aligned holes at an edge of respective collated books for binding the books;
an end crimping device for engaging and crimping ends of an inserted helical coil for forming a crimped end of the coil to inhibit release of the inserted coil from the collated book
and a heating device for applying heat to the coils after discharge from the forming assembly and prior to engagement thereof by the end crimping device.

11. The apparatus according to claim 10 wherein the heating device is arranged so as to apply heat to the coils such that the coils when they reach the end crimping device are at a temperature above 25 degrees C. and preferably above 30 degrees C.

12. The apparatus according to claim 10 wherein the heating device comprises a fan for generating air flow, a heating element for heating the air flow and an air guide for directing the air onto the coils.

13. The apparatus according to claim 10 wherein the heating device comprises a contact heating element for engaging and applying heat to a surface on which the coils rest.

14. The apparatus according to claim 10 wherein the heating device comprises a fan for generating air flow, a heating element for heating the air flow and an air guide for directing the air onto the coils and a contact heating element for engaging and applying heat to a surface on which the coils are arranged to rest.

15. Apparatus for binding a book with a helical plastic coil comprising:
a forming assembly for forming helical coils from an elongate plastics material;
an insertion assembly for inserting the helical coils into aligned holes at an edge of respective collated books for binding the books;
an end crimping device for engaging and crimping ends of an inserted helical coil for forming a crimped end of the coil to inhibit release of the inserted coil from the collated book
and an insulation arrangement arranged to prevent cooling of the coils to a temperature below 25 degrees C. after discharge from the forming assembly and prior to engagement thereof by the end crimping device.

16. The apparatus according to claim 15 wherein the insulation arrangement is arranged so as to prevent cooling a temperature below 30 degrees C.
